(19) United States
(12) Patent Application Publication
(10) Pub. No.: US 2016/0140476 A1
(43) Pub. Date: May 19, 2016

(54) METHODS, SYSTEMS AND APPARATUS FOR HUMAN JUDGES, PRODUCTS AND SERVICES EVALUATIONS

(71) Applicant: eBay Inc., San Jose, CA (US)

(72) Inventors: James Rubinstein, Saratoga, CA (US); Manas Haribhai Somaiya, Sunnyvale, CA (US)

(21) Appl. No.: 15/005,802

(22) Filed: Jan. 25, 2016

Related U.S. Application Data
(63) Continuation of application No. 13/722,181, filed on Dec. 20, 2012.

(51) Int. Cl. G06Q 10/06; G06Q 30/08

(52) U.S. Cl. CPC G06Q 10/06398; G06Q 30/08

(57) ABSTRACT

A computerized method for evaluating human judges, products and services. An amount of currency for bidding and a corresponding plurality of items, with each item having a defined price, may be presented to a user. A bid for one or more of the plurality of items may be obtained. The one or more bids may each be compared with a defined price of the corresponding item. A score may be determined based on the one or more bids. Products, services, and search algorithms and techniques may be evaluated based on the bids, and search algorithms and techniques may be developed based on the bids. Human judges may be evaluated based on results of the corresponding bids.

### PRIORITY

This application is a continuation of and claims the benefit of priority to U.S. patent application Ser. No. 13/722,181, filed on Dec. 20, 2012, which is hereby incorporated by reference herein in its entirety.

### TECHNICAL FIELD

The present application relates generally to the evaluation of human judges, products, and services, and more specifically, in one example, to a gaming system that evaluates human judges, products, and services, and measures a quality of search results.

### BACKGROUND

Human judgments are often used for measuring the quality of a search result. For example, value judgments by human beings may be used for measuring the quality of the results of a search for an item or service to purchase. Human judgments may also be used to determine what people may buy and at what price, and may determine how to engage people in product and service sales and auctions, including on-line auctions. It can be challenging, however, to incentivize human, or “crowd sourced,” judges to approximate, for example, a shopper in a relevant and accurate manner.

In order to maintain quality, human judgment tasks typically use gold, or gold standard, units. Gold and gold standard units have known annotation values, so that a human judge can be scored against them. If the human judge selects a wrong answer, the human judge may be penalized. If the human judge is not paying proper attention to the human judgment task or is trying to maximize their own revenue at the expense of the quality of the judgment, the human judge may also be penalized.

### BRIEF DESCRIPTION OF THE DRAWINGS

Some embodiments are illustrated by way of example and not limitation in the figures of the accompanying drawings in which:

FIG. 1 shows a table illustrating awards for a human judgment task, in accordance with an example embodiment;

FIG. 2 is a network diagram depicting a client-server system, within which one example embodiment may be deployed;

FIG. 3 is a block diagram illustrating multiple applications, described more fully below, that, in one example embodiment, are provided as part of the networked system;

FIG. 4A is an example representation of a query session table, in accordance with an example embodiment;

FIG. 4B is an example representation of a bid records table, in accordance with an example embodiment;

FIG. 5 is a block diagram of an apparatus, in accordance with an example embodiment, for performing human judgment tasks;

FIG. 6 is a flowchart for a human judgment gaming method, in accordance with an example embodiment;

FIG. 7 is an example representation of a user interface for displaying a query session and obtaining bids on one or more items, in accordance with an example embodiment; and

FIG. 8 is a block diagram of a computer processing system within which a set of instructions, for causing the computer to perform any one or more of the methodologies discussed herein, may be executed.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

### OVERVIEW

Understanding the true value and/or perceived value of an item available for purchase may be a key aspect of understanding, for example, shopping trends, including online shopping trends and shopping trends at auctions. Knowledge of the true value and/or perceived value of an item may also be useful in measuring the quality of a search result, developing search algorithms and methods, and maximizing the relevance of search results. Measuring the quality of search results, in turn, may enable the measurement and improvement of, for example, ranking algorithms, such as algorithms that rank products and/or services.

Quality measurements for search results for a product or service may be based on judgments by human beings. For example, human judgments may provide information on the value of a product or service and/or the relevance of a product or service identified in a search result. Human judgments may also be used to determine how to engage people in product and service sales and auctions, and how to determine what people may buy and at what price. It can be challenging, however, to get human, or “crowd sourced,” judges to approximate, for example, an online shopper.

In accordance with one example embodiment, the value judgments for a product or service may be based on the relative distribution of currency that a user, or human judge, gives to items that are presented for sale. For example, if a user enters a bid on a first item that is twice the value of a bid for a second item, the first item may be considered to be twice as valuable, or twice as relevant a result for the query, as the second item. If an item receives no bid, the item may be considered to be a less valuable item, or a less relevant result for the query, than an item that receives a bid. In one example embodiment, the product or service may be presented in response to a query for a product or service. In one example embodiment, the product or service may be presented without a corresponding query.

In one example embodiment, a real world shopping experience is created for a human judge by presenting a set of associated products and/or services and an allocated amount of currency. In one example embodiment, a real world shopping experience is created for a human judge by presenting a query, a list of items in the form of a query result list, and an allocated amount of currency for the human judge to spend. Each product or service is known as an “item,” and the set of associated products and/or services is known as a set of “query result items.” Each query and corresponding set of query result items is known as a “query session.” Each set of query result items may be displayed, for example, as a list of textual descriptions, graphical representations, images, and the like. Each item may be associated with a defined price for the item (as described more fully below).

Currency may be allocated for each query, for example, based on the defined price of one or more items in the set of query result items. In one example embodiment, the currency may be virtual currency. In one example embodiment, the currency may represent the currency of a nation or a union of nations.

During a query session, the user may indicate a price, also known as a bid, for one or more items in the set of query result items. In one example embodiment, the indicated price may be the price the user would be willing to pay for the item. In one example embodiment, the indicated price may be the price the user believes the item in the set of query result items may be worth.

A user, or human judge, may earn points and/or credits for each item where the bid price is greater than or equal to the defined price of the item, also known as a winning bid. In one example embodiment, points and/or credits may be awarded to the user following the submission of one or more bids for each query session. In one example embodiment, points and/or credits may be awarded to the user following the submission of one or more bids for a plurality of query sessions. The points and/or credits may be accumulated over a human judgment session of one or more query sessions. The bidding and awarding of the cited points and/or credits may create a type of gaming environment for the human judgment task and may incentivize the user to provide accurate and/or relevant bids. In the present disclosure, the terms user, human judge, and player may be used synonymously.

A human judgment competition may be defined where two or more players compete. In one example embodiment, a human judgment competition may be defined by composing a game comprising one or more queries presented to one or more users, or players. In one example embodiment, players of a game may be provided the same set of query sessions. In one example embodiment, each player of a game may be provided a different set of query sessions.

A user's standing in the game may be based on an amount of points and/or credits awarded during the game and/or human judgment session. In one example embodiment, the user who accumulates the most points and/or credits wins the game and/or human judgment session. In one example embodiment, a user wins a game by spending the least amount of virtual currency while purchasing all the items in a set of items. In one example embodiment, a user wins a game by spending the least amount of virtual currency while purchasing a subset of the items in a set of items. In one example embodiment, a user wins by achieving winning bids on the largest percentage of items. In one example embodiment, a user wins by achieving winning bids on the largest number of items.

In one example embodiment, rewards and/or prizes are awarded to the one or more users who are awarded the most points and/or credits. In one example embodiment, rewards and/or prizes are awarded to the one or more users who win a game and/or human judgment session. In one example embodiment, rewards and/or prizes are awarded to one or more users attaining the highest score(s) in relation to other users, as described more fully below.

### Defined Price

In one example embodiment, the defined price of an item may be obtained from a completed auction, a current price at a pending auction, a reserve price at an auction, a for-sale listing, a log, and the like. For example, online listings of items for sale may be scanned, and the average list price may be assigned as the defined price for the corresponding item. In one example embodiment, the defined price of an item may be estimated. For example, a statistical property such as a mean or median over the prices of one or more similar items may be used to determine a defined price. In one example embodiment, the defined price of the item may correspond to a price for which an item sold at an auction. In one example embodiment, the defined price may correspond to a fixed price and/or asking price indicated by a seller of an item. In one example embodiment, the defined price may correspond to a fixed price, an advertised price, and/or an asking price indicated by a commercial retail seller of an item.

In one example embodiment, the defined price may be based on one or more bids from one or more executed query sessions. For example, the defined price may be based on an average of the bids for an item that were entered during the previous twenty-five query sessions.

In one example embodiment, Similar Items Clustering (SIC) is used to estimate a price. SIC clusters “similar” items based on various item attributes, such as current item taxonomy and item title.

In one example embodiment, Similar Items Metrics may be used to estimate a price based on value metrics from similar sold items occurring during the last N days. In one example embodiment, the value metrics include multiple fields in the areas of: 1) pricing (such as one or more medians of final price, shipping cost, and total cost); 2) historic demand and/or attractiveness parameters (such as one or more medians of clicks, bids, watches, sold count, impressions, click-through rate (CTR), sales/impression, and number of sold items found); and 3) listing characteristics (such as medians of listing duration).

In one example embodiment, a defined price may be revised based on updated pricing information. In one example embodiment, the defined price of one or more items may be updated based on pending bids in an on-going auction, accepted bids in a completed auction, and/or new or updated listing prices of a seller.

### Bidding and Strategy

In one example embodiment, a user may be allowed to bid up to the entire amount of currency allocated to a query on a single item in the set of items corresponding to the query. In one example embodiment, a user may bid up to the entire amount of currency allocated to a query on each of a plurality of items in the set of items corresponding to the query. In one example embodiment, the total value of all bids corresponding to a particular query may not exceed the amount of currency allocated to a corresponding query.

In one example embodiment, a user may be required to bid on only a subset of a set of query result items. In one example embodiment, a player may be required to bid on every item in a set of query result items. In one example embodiment, a player may enter a bid of zero on one or more items in a set of query result items.

Users may use different strategies to win bids and be awarded points and/or credits, and/or win a game or human judgment competition. For example, if permitted, a user may bid the full allocation of currency on a single item and may be guaranteed to succeed in having the bid price be greater than or equal to the price of the item, thus achieving a winning bid on at least one item.

In one example strategy, a user may attempt to efficiently allocate the allotment of currency by bidding at or just above the defined price of a plurality of items and thereby attempt to achieve winning bids on a plurality of items.

### Awarding Points and Credits

In one example embodiment, a game may be defined that comprises one or more query sessions, where each query corresponds to a set of query result items. A player accumulates points and/or credits based on the results of bidding on items listed in each set of query result items. In one example embodiment, the system may keep track of one or more metrics based on the set of query result items and bids, and may award a user points and/or credits based on one or more of the metrics.

In one embodiment, the system may award currency to a user based on one or more of the following rules:

Rule 1: The system may award a user with currency equivalent to the defined price of the most expensive item of a query that is associated with a winning bid.

Rule 2: The system may award a user with currency equivalent to the difference between the amount of currency allocated and the bid price of the most expensive item for the corresponding query that is associated with a winning bid.

Rule 3: The system may award a user with currency equivalent to the difference between the amount of allocated currency and the bid price of the least expensive item for the corresponding query that is associated with a winning bid.

Rule 4: The system may award a user with currency equivalent to the defined price of the least expensive item of a query that is associated with a winning bid.

Rule 5: The system may award a user with an amount of virtual currency equivalent to the sum of currency saved on each item in a query that is associated with a winning bid, where the currency saved on an item may be equal to the difference between the amount of allocated currency for the corresponding query and the bid price.

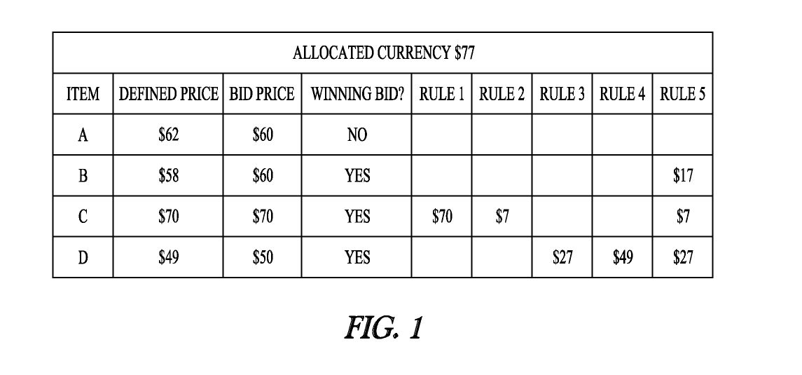

FIG. 1 shows a table illustrating awards for a human judgment task, in accordance with an example embodiment. Rules 1 through 5 of the table of FIG. 1 correspond to rules 1 through 5 described above. Items A through D represent the query result list for an example query session associated with the table of FIG. 1. For the example query session of FIG. 1, 77 dollars in virtual currency is allocated. For each item, the defined price and bid price are shown. In the example embodiment, the bid price must equal or exceed the defined price to be a winning bid. Accordingly, in the table of FIG. 1, items B through D received winning bids. According to rule 1, 70 dollars in virtual currency would be awarded since the defined price of the item associated with the most expensive winning bid, i.e., the defined price for item C, is 70 dollars. According to rule 2, seven dollars in virtual currency would be awarded since the difference between the amount of currency allocated for the corresponding query (77 dollars) and the bid price (70 dollars) of the most expensive item associated with a winning bid, i.e., the bid for item C, is seven dollars. According to rule 3, 27 dollars in virtual currency would be awarded since the difference between the amount of currency allocated for the corresponding query (77 dollars) and the bid price (50 dollars) of the least expensive item associated with a winning bid, i.e., the bid for item D, is 27 dollars. According to rule 4, 49 dollars in virtual currency would be awarded since the defined price of the least expensive item associated with a winning bid, i.e., the bid for item D, is 49 dollars. According to rule 5, 51 dollars in virtual currency would be awarded since the sum of currency saved on each item that attained a winning bid, where the currency saved on an item is equal to the difference between the amount of allocated currency for the corresponding query and the bid price, is 51 dollars.

In one example embodiment, a user receives points and/or credits by spending the least amount of currency while purchasing one or more items in a set of query result items. In one example embodiment, a query result list may contain two items and a user may receive points and/or credits by entering winning bids on both items. In one example embodiment, a query result list may contain two items and a user may receive points and/or credits by entering winning bids on both items, where the points and/or credits received may be inversely proportional to the amount of currency utilized in purchasing both items.

In one example embodiment, a user may receive points and/or credits by identifying an item in a query result list that failed to sell and/or sold a small number of units. In one example embodiment, a user may receive points and/or credits by identifying an item in a query result list that sold a number of units that is less than a predefined target value. In one example embodiment, a user may receive points and/or credits by entering winning bids on one or more of the remaining items after identifying an item that failed to sell and/or sold a small number of units.

In one example embodiment, a query result list comprising a plurality of items and a plurality of corresponding prices may be displayed. A user may receive points and/or credits by identifying one or more items in the query result list that failed to sell and/or sold a small number of units. In one example embodiment, the small number of units is based on a predefined target value.

In one example embodiment, the number of points and/or credits awarded may be inversely proportional to an amount of currency used for all of the winning bids in a query session. In another example embodiment, the number of points and/or credits awarded may be proportional to an amount of currency saved on all of the winning bids in a query session, where the currency saved on an item may be equal to the difference between the amount of allocated currency for the corresponding query and the bid price.

In one example embodiment, a player may accumulate points and/or credits by maximizing the number of winning bids, i.e., by maximizing the number of bids that equal or exceed the corresponding defined price. In one example embodiment, a player may accumulate points and/or credits by maximizing the percentage of bids that equal or exceed the corresponding defined price.

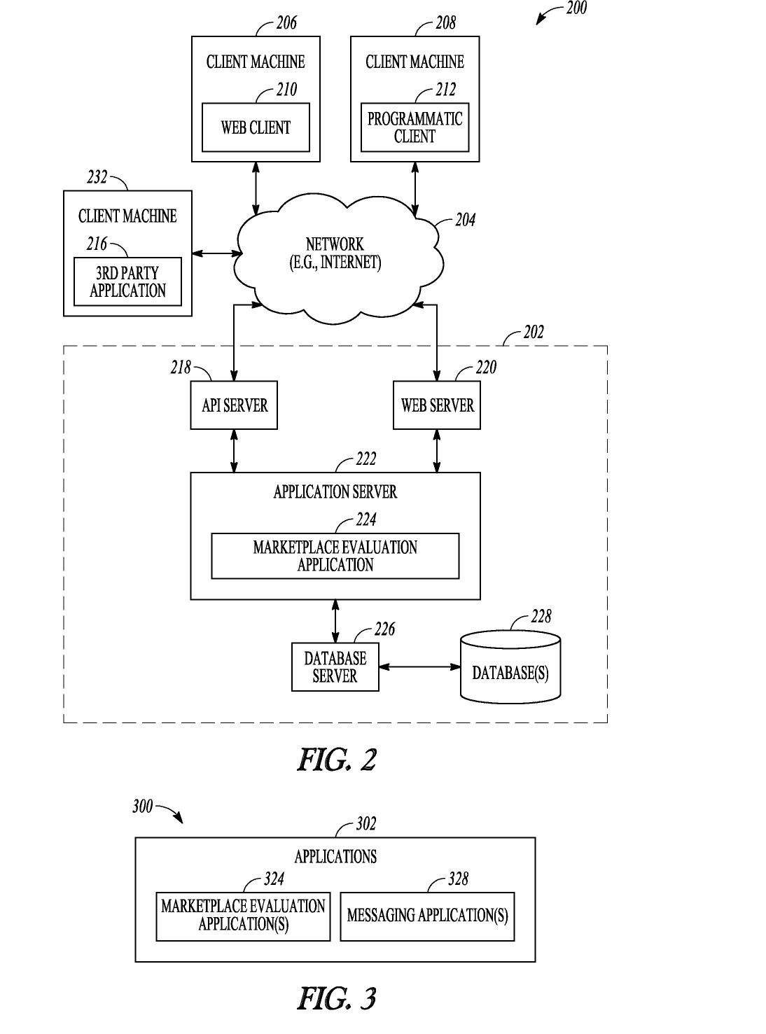

FIG. 2 is a network diagram depicting a client-server system 200, within which one example embodiment may be deployed. A networked system 202, in the example forms of a network-based marketplace evaluation system, provides server-side functionality, via a network 204 (e.g., the Internet or Wide Area Network (WAN)) to one or more clients. FIG. 2 illustrates, for example, a web client 210 (e.g., a browser, such as the Internet Explorer browser developed by Microsoft Corporation of Redmond, Wash. State), and a programmatic client 212 executing on respective client machines 206 and 208.

An Application Program Interface (API) server 218 and a web server 220 are coupled to, and provide programmatic and web interfaces respectively to, one or more application servers 222. The application servers 222 host one or more marketplace evaluation applications 224. The application servers 222 are, in turn, shown to be coupled to one or more databases servers 226 that facilitate access to one or more databases 228.

The marketplace evaluation application(s) 224 may provide a number of marketplace evaluation functions and services to users that access the networked system 202.

Further, while the system 200 shown in FIG. 2 employs a client-server architecture, the present invention is of course not limited to such an architecture, and could equally well find application in a distributed, or peer-to-peer, architecture system, for example. The marketplace evaluation application(s) 224 could also be implemented as standalone software programs, which do not necessarily have networking capabilities.

The web client 210 accesses the marketplace evaluation application(s) 224 via the web interface supported by the web server 220. Similarly, the programmatic client 212 accesses the various services and functions provided by the marketplace evaluation application(s) 224 via the programmatic interface provided by the API server 218. The programmatic client 212 may, for example, be a seller application (e.g., the TurboLister application developed by eBay Inc., of San Jose, Calif.) to enable sellers to author and manage listings on the networked system 202 in an off-line manner, and to perform batch-mode communications between the programmatic client 212 and the networked system 202.

FIG. 2 also illustrates a third party application 216, executing on a third party server machine 232, as having programmatic access to the networked system 202 via the programmatic interface provided by the API server 218. For example, the third party application 216 may, utilizing information retrieved from the networked system 202, support one or more features or functions on a website hosted by the third party. The third party website may, for example, provide one or more promotional, marketplace or payment functions that are supported by the relevant applications of the networked system 202.

### Marketplace Evaluation Applications

FIG. 3 is a block diagram illustrating multiple applications 302, described more fully below, that, in one example embodiment, are provided as part of the networked system 202. The multiple applications 302 may be hosted on dedicated or shared server machines (not shown) that are communicatively coupled to enable communications between server machines. The applications 302 themselves are communicatively coupled (e.g., via appropriate interfaces) to each other and to various data sources, so as to allow information to be passed between the applications 302 or so as to allow the applications 302 to share and access common data. The applications 302 may furthermore access one or more databases 228 via the database servers 226.

Messaging application(s) 328 are responsible for the generation and delivery of messages to users of the networked system 202, such messages, for example, advising users regarding the status of query sessions. Respective messaging applications 328 may utilize any one have a number of message delivery networks and platforms to deliver messages to users. For example, messaging applications 328 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Marketplace evaluation applications 324 are responsible for enabling human judgment tasks for users of the networked system 202, such tasks, for example, including the execution of query sessions.

### Data Structures

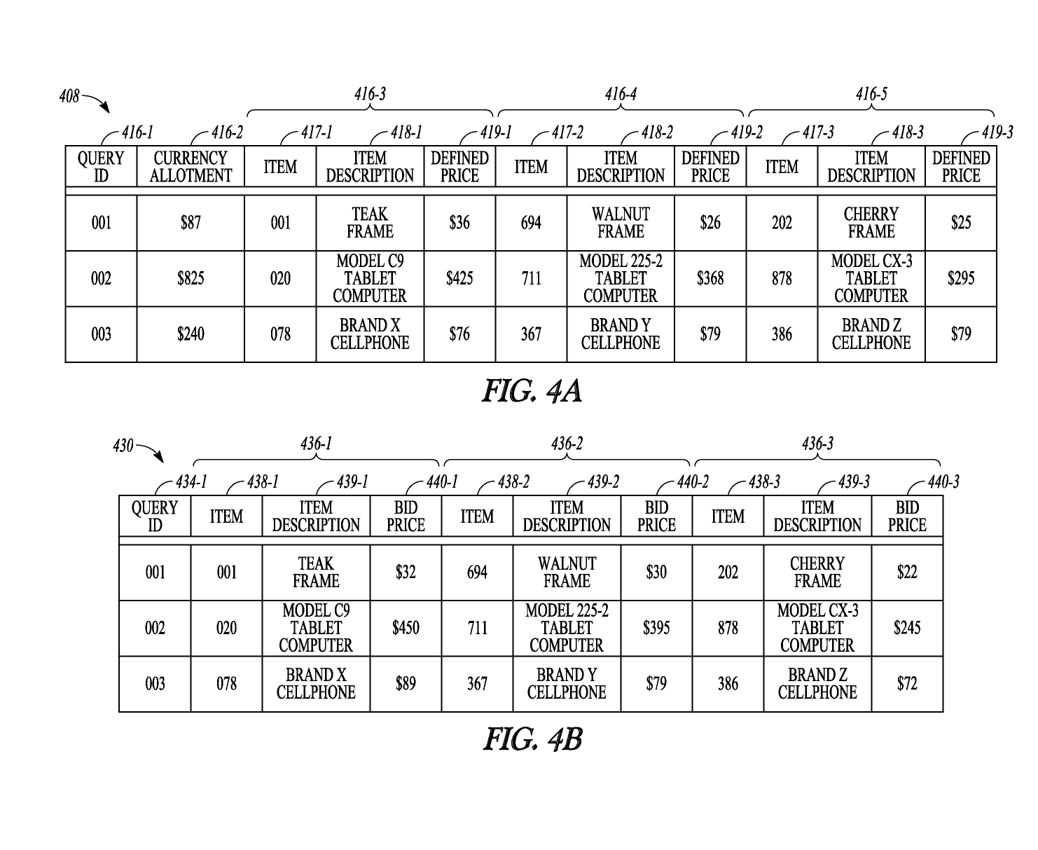

FIG. 4A is an example representation of a query session table 408, in accordance with an example embodiment. The query session table 408 may comprise an array of rows and columns, where each row corresponds to a query session. Column 416-1 corresponds to a query identifier field, column 416-2 corresponds to a currency allotment field, and columns 416-3 through 416-5 correspond to item fields. Each item field comprises an item identification sub-field 417-1 through 417-3, an item description sub-field 418-1 through 418-3, and a defined price sub-field 419-1 through 419-3.

FIG. 4B is an example representation of a bid records table 430, in accordance with an example embodiment. The bid records table 430 maintains a record of bids obtained for each query session, where each row corresponds to a query session. Column 434-1 corresponds to a query identification field, and columns 436-1 through 436-3 correspond to item fields. Each item field comprises an item identification sub-field 438-1 through 438-3, an item description sub-field 439-1 through 439-3, and a bid price sub-field 440-1 through 440-3.

### Marketplace Evaluation Apparatus

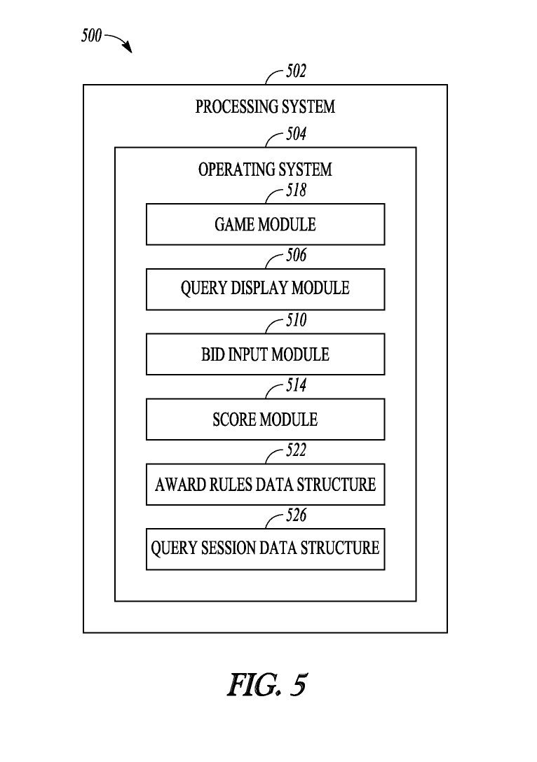

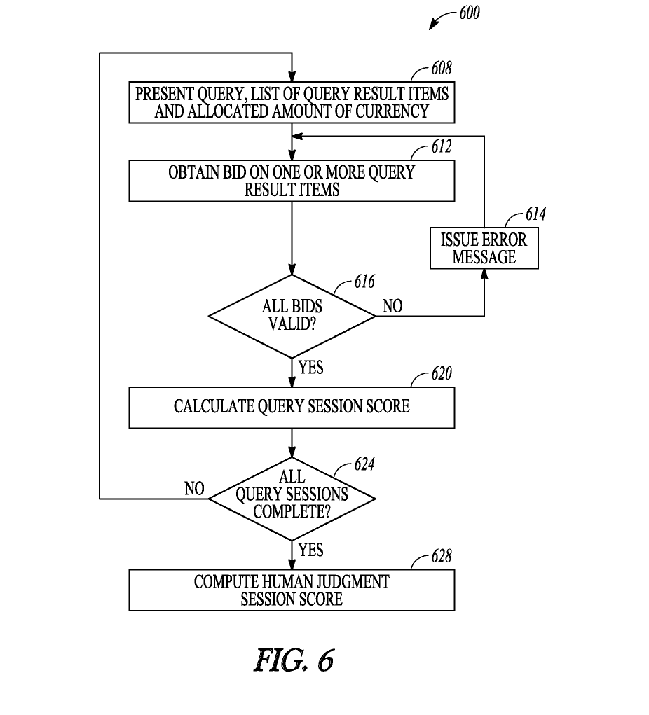

FIG. 5 is a block diagram of an apparatus, in accordance with an example embodiment, for performing human judgment tasks. For example, the apparatus 500 may be used to perform a human judgment task and, accordingly, is described by way of example with reference thereto.

The apparatus 500 is shown to include a processing system 502 that may be implemented on a server, client, or other processing device that includes an operating system 504 for executing software instructions. In accordance with an example embodiment, the apparatus 500 includes a query display module 506, a bid input module 510, a query session score module 514, and a game and competition module 518. In accordance with an example embodiment, the apparatus 500 includes an award rules data structure 522 and a query session data structure 526.

The query display module 506 may present an amount of currency and may present a plurality of items for a corresponding query session. The bid input module 510 may obtain a bid for each of one or more of the plurality of items presented during a query session. The query session score module 514 may compare one or more of the bids with a defined price of a corresponding item, and may determine a score based on the one or more bids. The game and competition module 518 may coordinate each query session for a user and/or for a plurality of users. In one example embodiment, the game and competition module 518 may coordinate a competition among a plurality of users and may determine one or more winners of a human judgment competition. The award rules data structure 522 may comprise one or more rules for determining points, credits, awards and/or prizes for a user. The query session data structure 526 may comprise, for example, query session table 408.

### Game Flowchart

FIG. 6 is a flowchart for a human judgment gaming method 600, in accordance with an example embodiment.

In one example embodiment, a query, a corresponding list of query result items, and an allocated amount of currency may be presented to a user (step 608). In one example embodiment, a list of items and an allocated amount of currency may be presented to a user, and a query may not be presented to the user.

In one example embodiment, the amount of currency allocated may be based on the price of the query result item that is associated with the highest price in the corresponding list of query result items. In one example embodiment, the amount of currency allocated may be based on a price of the query result item corresponding to the highest price in the corresponding list of query result items multiplied by a multiplication factor. For example, the price of the item corresponding to the highest price in the list of query result items may be multiplied by a multiplication factor of 1.10. In one example embodiment, the amount of currency allocated may be based on a sum of the defined prices corresponding to each of the query result items in the corresponding list of query result items.

In one example embodiment, the list of query result items may be predefined. In one example embodiment, the list of query result items may be generated by searching a database of items based on one or more terms of a query. In one example embodiment, the search of a database may be based on terms defined and/or selected by the user or human judge. In one example embodiment, the list of query result items may be obtained from a completed auction. In one example embodiment, the list of query result items may be obtained from an auction that is in progress. In one example embodiment, the list of query result items may be selected from a master list of items by, for example, the user or human judge.

Following the presentation of the query, a user may review the list of query result items and may enter a bid on each of one or more of the query result items utilizing the allocated amount of currency (step 612). In one example embodiment, the user may bid up to the total amount of currency allocated to a corresponding query on a single item in the list of query result items. In one example embodiment, the user may bid up to the total amount of currency allocated to a corresponding query on each item in the list of query result items. In one example embodiment, the user may bid only a predefined percentage of the total amount of currency allocated to a corresponding query on a single item in the list of query result items. In one example embodiment, the total value of all bids corresponding to a particular query must not exceed the amount of currency allocated to a corresponding query.

In one example embodiment, a user may choose not to bid on one or more items in a set of query result items. In one example embodiment, a user must bid an amount of currency on each item in a set of query result items. In one example embodiment, a player may enter a bid of zero on one or more items in a set of query result items.

In one example embodiment, a test may be performed on each bid to determine if the bids are valid (step 616). For example, a test may be performed to determine if the sum of the bids exceeds the allocated amount of currency. If the sum of the bids exceeds the allocated amount of currency, an error message is issued and the user is requested to re-enter the bid(s) for the one or more items (step 614).

If the sum of the bids does not exceed the allocated amount of currency, a score may be calculated for the query session and points and/or credits awarded (step 620), as described more fully below. As noted above, a user, or human judge, may earn points and/or credits for each item where the bid price is greater than or equal to the defined price. The points and/or credits may be accumulated over a human judgment session comprising one or more queries.

A test may be performed to determine if one or more query sessions remain unprocessed (step 624). If one or more query sessions have not been processed, another query session may be selected and the method may proceed with step 608; otherwise, an optional overall human judgment session score may be computed based on the executed query session(s) and any additional points and/or credits may be awarded (step 628). For example, additional points and/or credits may be awarded for winning a human judgment competition.

In one example embodiment, a user may be allowed to move to a next query session only if at least one bid is a winning bid (i.e., a bid that equals or exceeds the defined price of the item).

### Example User Interface

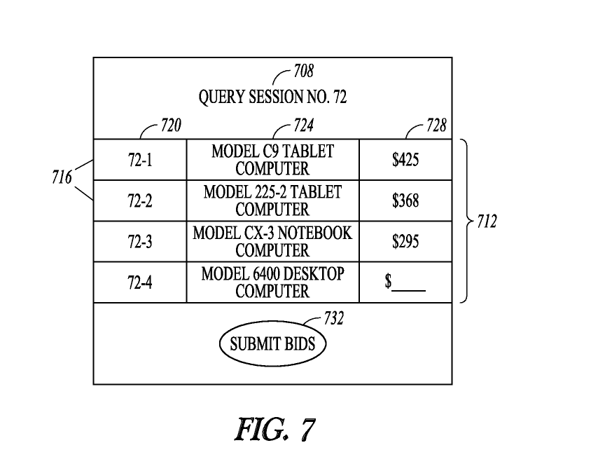

FIG. 7 is an example representation of a user interface for displaying a query session and obtaining bids on one or more items, in accordance with one example embodiment. A query session identifier 708 identifies the current query session. Table 712 comprises a row 716 for each query result item. Each row 716 comprises a query result item identification field 720, a query result item description field 724, and a bid price entry field 728. A user may enter a bid for a query result item in the corresponding bid price entry field 728. Once all bids have been entered, a user may depress the “Submit Bids” button 732 to have the bid(s) entered into, for example, bid records table 430.

### Winning a Game

In one example embodiment, a game and/or human judgment session may comprise one or more query sessions presented to one or more users. In one example embodiment, each user of a game may be provided the same set of queries. In one example embodiment, each user of a game may be provided a different set of queries. A user's standing in the game and/or human judgment session may be based on an amount of points and/or credits that may be awarded during the game. In one example embodiment, the user who accumulates the most points and/or credits may win the game. In one example embodiment, any user who accumulates at least a predefined number of points and/or credits may be a winner.

In one example embodiment, a user may win a game by spending the least amount of virtual currency in purchasing all the items in a set of items. In one example embodiment, a user may win a game by spending the least amount of virtual currency in purchasing a subset of the items in a set of items.

In one example embodiment, prizes may be awarded to the one or more users who are awarded the most points and/or credits.

### Formulating Queries

Query sessions may be formulated using a number of novel techniques. In one example embodiment, queries may be generated by a human judge who may specify, or may select from a predefined list, one or more query terms and corresponding list of query result items. In one example embodiment, queries may be generated by a human judge who may specify, or may select from a predefined list, one or more lists of query result items. In one example embodiment, the list of query result items may be derived by searching a database of items, a catalog, a manufacturer's database, a distributor's database, a merchant's database, and the like. In one example embodiment, the list of query result items may include one or more items reported as problematic. For example, the list of query result items may include one or more items reported as problematic to a customer support center. In one example embodiment, the list of query result items may be predefined. For example, a query may be generated for a particular product, a category of product, a particular service, a category of service, a brand, a model, an item characteristic or attribute, and the like. For example, a query may be generated based on the term “tablet computer.”

In one example embodiment, a list of items to be judged may be specified, and a query term may be defined based on the corresponding list of items. For example, a list of different brands and/or models of tablet computers may be defined, and a query based on the list, such as a query of the term “tablet computers,” may be generated. The bid(s) generated by a user may then be used to identify the most popular and/or valuable item(s) in the list of items based, for example, on the amount of the bid or the difference between the amount of the bid and the defined price.

In one example, a list of a particular type of an item may be defined where one or more of the items in the list have a different type of attribute. For example, the type of item may be a tablet computer, and one tablet computer in the list may have an external video output, one tablet computer may have a wireless keyboard interface, and so on. The bid(s) of a user may then be used to identify the most popular and/or most valuable type of attribute for the tablet computer.

In one example embodiment, a list of tablet computers may be defined where one or more of the tablet computers have a common type of attribute with a different associated value. For example, the attribute may be a color of the item and the associated value can be one or more of red, green, and blue. The bid(s) of a user may then be used to identify the most valuable and/or popular attribute value. For example, the bid(s) for a green tablet computer may be higher than the bid(s) for a red tablet computer. The most popular and/or valuable color of the item may then be determined to be green.

### Evaluation, Metrics, and Data Mining

Understanding the true value and/or perceived value of an item available for purchase may be a key aspect of understanding, for example, shopping trends, including online shopping trends and shopping trends at auctions. Knowledge of the true value and/or perceived value of an item may also be useful in measuring the quality of a search result, developing search algorithms and methods, and maximizing the relevance of search results.

For example, if a user enters a bid on a first item that is twice the value of a bid on a second item, the first item may be considered to be twice as valuable, or twice as relevant a result for the query, as the second item. If an item receives no bid, the item may be considered to be a less valuable item, or a less relevant result for the query, than an item that receives a bid. An analysis of bids may therefore provide an indication of the most popular and/or valuable product, service, brand, model, item attribute or characteristic, and the like.

A Value Ratio may be defined as a bid price for an item divided by the defined price of the item. The bid price may be based on a single bid or an average of a plurality of bids. The defined price may be based on an estimate of a price, an asking price, a bid price, a listing price, an anticipated price, a price for which the item has sold, and the like. If the associated bid amount is higher than the corresponding defined price, it may indicate that an item is desirable and/or undervalued, and the item may therefore be considered to be a ‘good value.’ If the associated bid amount is lower than the corresponding defined price, it may indicate that an item is not desirable and/or is overvalued, and the item may therefore be considered to be a ‘poor value.’ The value ratio may be used as an additional input to search ranking and/or cataloging algorithms and techniques, and/or the development of search ranking and/or cataloging algorithms and techniques.

In one example embodiment, an output of the method may be a rank-ordered list of preferred items. For example, a rank-ordered list of items associated with a high value ratio may be generated. In one example embodiment, the rank-order is based on the bid amount of an item. In one example embodiment, the rank-order is based on the difference between a bid amount of an item and a defined price of the item.

For queries that are formulated for a type of product, a type of service, a brand, a model, an item attribute, and/or other characteristic, the corresponding bids may be analyzed to determine the most valuable and/or most popular type of product, type of service, brand, model, item attribute, and the like. In one example embodiment, as described more fully above, a list of tablet computers is defined where one or more of the tablet computers have a common type of attribute with a different associated value. For example, the attribute may be a color, and the associated value can be one or more of black, white, and blue. The bid(s) of a user may then be used to identify the most valuable and/or popular attribute value. In one example embodiment, a rank ordered list of the most valuable and/or popular attribute values may be generated.

The bidding results and/or corresponding game results may also be used to determine the users, players, and human judges that provide the most accurate and/or relevant bids. For example, the users, players, and human judges may be ranked according to the total number of points and/or credits awarded during a human judgment competition.

The bidding results and/or corresponding game results may be used to tune search algorithms and techniques to return high value, highly relevant, and/or highly desirable items in response to a search. For example, a list of high value ratio items may be provided to an online shopper of products and/or services.

The bidding results and/or corresponding game results may be used to generate a report of the most valuable and/or most desirable type of product, type of service, brand, model, and/or attribute of an item. For example, as described more fully above, a query for a tablet computer may be defined where one or more tablet computers in the query result list are associated with a different attribute, and the resulting bids indicate which attribute is most valuable. The bidding results and/or corresponding game results may also be used to rank value-characteristic pairs and/or a relative value of an attribute. For example, a value-characteristic pair may be based on a color of a product and an associated value, and the resulting value-characteristic pairs may be ranked. For example, a white cellular phone may have a value ratio of 0.9 and a black cellular phone may have a value ratio of 1.2. Thus, the value-characteristic pair 1.2-black would be ranked higher than the value-characteristic pair 0.9-white.

One or more of the methods outlined above may be applied to fixed price listings. In one example embodiment, fixed price listings may be considered a special case of auctions where the users are informed of a fixed price of the item before entering a bid for the item.

Although certain examples shown and described here, other variations exist and are within the scope of the invention. It will be appreciated by those of ordinary skill in the art that any arrangement which is designed or arranged to achieve the same purpose may be substituted for the specific embodiments shown. This application is intended to cover any adaptations or variations of the example embodiments of the invention described herein. It is intended that this invention be limited only by the claims, and the full scope of equivalents thereof.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

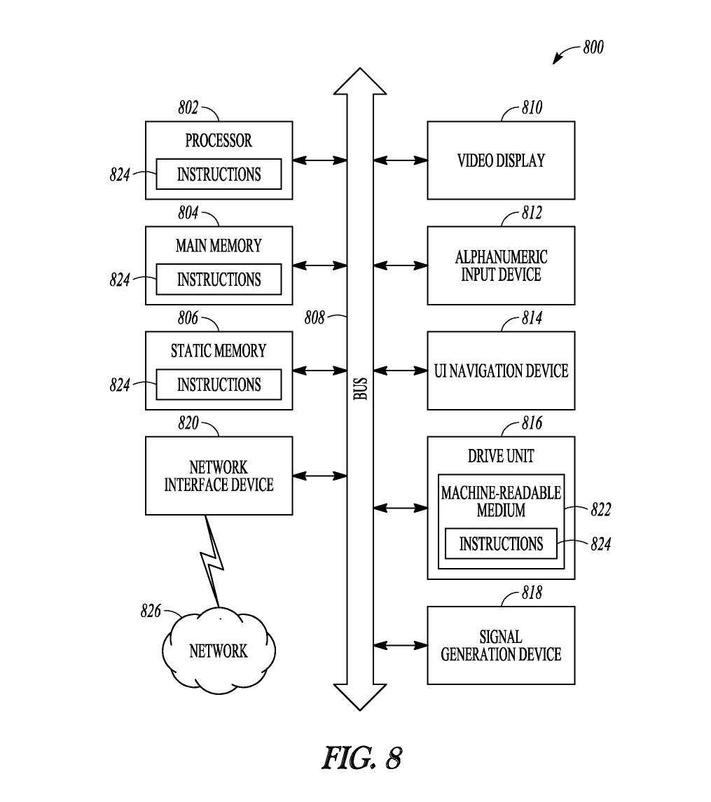

FIG. 8 is a block diagram of machine in the example form of a computer system 800 within which a set of instructions, for causing the machine to perform any one or more of the methods discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The software 824 may further be transmitted or received over a communications network 826 using a transmission medium. The software 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus to perform an evaluation, the apparatus comprising:
an electronic display interface for presenting to a user, on an electronic display: an allocated amount of currency for bidding by the user, and a list of a plurality of items from an item listing data structure, each item having a defined price; and
an evaluation module comprising a hardware-based scoring function for determining a score based on one or more bids for each of at least a subset of the plurality of items, the one or more bids obtained from a bid data structure, each bid comprising a value determined by the user.

2. The apparatus of claim 1, wherein the instructions, when executed by the processor, further cause the processor to present a query; and
wherein the list of items is a list of query result items.

3. The apparatus of claim 1, wherein the amount of currency allocated is based on a sum of prices, each price corresponding to one of the plurality of items.

4. The apparatus of claim 1, wherein the score is based on a difference between the amount of allocated currency and a highest bid that equals or exceeds a price of a corresponding item.

5. The apparatus of claim 1, wherein the score is based on a lowest defined price of one or more defined prices corresponding to one or more items associated with a winning bid.

6. The apparatus of claim 1, wherein the score is based on a difference between the amount of allocated currency and a lowest bid that equals or exceeds a price of the corresponding item.

7. The apparatus of claim 2, wherein the score is based on a sum of one or more differences between the amount of allocated currency for the query and each bid that equals or exceeds a price of a corresponding query result item.

8. The apparatus of claim 2, wherein the score is based on a percentage of bids that equal or exceed a price of a corresponding query result item.

9. The apparatus of claim 1, wherein the plurality of items are selected based on a common type of attribute of two or more of the plurality of items.

10. The apparatus of claim 2, wherein a value of a query result item of the query result items is evaluated by comparing a bid corresponding to a query result item and a defined price of the corresponding item.

11. A non-transitory computer-readable medium embodying instructions that, when executed by a processor perform operations comprising:
presenting to a user, on an electronic display: an allocated amount of currency for bidding by the user, and a list of a plurality of items from an item listing data structure, each item having a defined price; and
determining, using a hardware-based scoring function, a score based on one or more bids for each of at least a subset of the plurality of items, the one or more bids obtained from a bid data structure, each bid comprising a value determined by the user.

12. A method to perform an evaluation, comprising:
presenting to a user, on an electronic display: an allocated amount of currency for bidding by the user, and a list of a plurality of items from an item listing data structure, each item having a defined price; and
determining, using a hardware-based scoring function, a score based on one or more bids for each of at least a subset of the plurality of items, the one or more bids obtained from a bid data structure, each bid comprising a value determined by the user.

13. The method of claim 12, further comprising presenting a query; and
wherein the list of items is a list of query result items.

14. The method of claim 12, wherein the amount of currency allocated is based on one or more of: 1) a price of an item associated with a highest defined price of the plurality of items; and 2) a sum of prices corresponding to each of the plurality of items.

15. The method of claim 12, further comprising selecting the plurality of items based on a common type of attribute of two or more of the plurality of items.

16. The method of claim 13, further comprising selecting the query result items for the query based on one or more of the following: a common type of product, a common category of product, a common type of service, a common category of service, a common brand, a common model, a master list of items, and a database of items.

17. The method of claim 15, further comprising evaluating a value of an attribute of an item based on a comparison of bids corresponding to the two or more items having the common type of attribute.

18. The method of claim 13, further comprising evaluating a value of a query result item by comparing a bid corresponding to an item and a defined price of the corresponding item.

19. The method of claim 13, wherein a sum of all bids corresponding to the query is limited to an amount equal to the allocated amount of currency.

20. The method of claim 12, further comprising generating a rank-ordered list of one or more of human judges, products, services, brands, models, item attributes, and value ratios of items.
